(19) United States
(12) Patent Application Publication
(10) Pub. No.: US 2003/0074346 A1
(43) Pub. Date: Apr. 17, 2003

(54) Information sharing system and method

(76) Inventors: Hitoshi Ueda, Fuji-shi (JP); Kenichi Matsubayashi, Fuji-shi (JP); Fujio Segawa, Mishima-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/269,859

(22) Filed: Oct. 15, 2002

(30) Foreign Application Priority Data
Oct. 12, 2001 (JP) 2001-315296

(51) Int. Cl. G06F 7/00

(52) U.S. Cl. 707/1

(57) ABSTRACT

An information sharing system for sharing information between a supply source of products and supply destinations of the products is provided. In the information sharing system, a database accumulating device accumulates pieces of information on each product, generated and inputted by the supply source and the supply destinations, respectively, in a database. An individual code identifying device identifies individual codes assigned to the supply source and the supply destinations, when the database of the database accumulating device is accessed by the supply source and the supply destinations, respectively. An information linking device links the pieces of information on the product, accumulated in the database of the database accumulating device, with each other, so that when a part of the pieces of information on the product in the database is changed by the supply source or any of the supply destinations, the pieces of information on the product accumulated in the database are updated by the information linking device.

### BACKGROUND OF THE INVENTION

1. Field of the Invention

The present invention relates to an information sharing system, and in particular to an information sharing system provided with a device for sharing information between a supply source and a supply destination.

2. Discussion of the Background

In OEM (original equipment manufacturing) businesses in which a product is manufactured by a supply source under a brand name of a client, i.e., a supply destination, various types of information are exchanged between the supply source and the client. For example, product quality information, process change information, material change information, etc. are provided from the supply source to the client, and specification change, claim information, etc, are provided from the client to the supply source. These types of information are generally exchanged between the supply source and the client via mail and facsimile, and are filed at each receiving side so that data is accumulated.

Various quality information management systems for use at the supply source side are known. One such exemplary system obtains, on-line and in real time, production process progress information, product quality information, etc., generated in each production process at the supply source. Another exemplary system obtains quality information of a product based on a quality information management value at each production process, and by evaluating characteristics of the quality information improvement in product quality and effectiveness of a countermeasure for defective products are quickly and accurately evaluated. Yet another exemplary system assigns identification information to product quality information at each production process of a product for each production lot of the product, so that the product quality information at each production process of the product is managed for the production lot.

Further, a system is proposed in which when parts of a product are delivered to a supply source, quality information of the parts is inputted into a computer to determine if the parts are ones incorporating a design change, and if the parts are determined as the ones incorporating the design change, the process management of the supply source is adjusted accordingly.

Thus, in background information systems for use in OEM businesses, an information generating side and an information receiving side own individual data accumulating systems, and based upon information exchanged between the information generating and receiving sides via mail, facsimile, telephone, meetings, etc., data is changed in or added to their individual data accumulating systems. Thus, due to a difference in timings of inputting data into their respective data accumulating systems, a perception gap occurs between the information generating side and the information receiving side. Therefore, because of the perception gap created due to difference in accumulated data on both the generating and receiving sides, both sides are presented with a difficulty in reaching a common understanding by referring to accumulated data in the respective data accumulating systems.

Further, quality information management systems practiced at the supply source side are generally configured such that information is not shared by clients.

### SUMMARY OF THE INVENTION

The present invention has been made in view of the above-discussed problems and to overcome them.

Preferred embodiments of the present invention provide a novel information sharing system for sharing information on a product between a supply source of the product and supply destinations of the product. The supply source and the supply destinations have a database for accumulating data about the product, and wherein, when a change to the product is necessary at the supply source or at each supply destination, by making similar changes to the data, about the product, accumulated in the database, information regarding the change to the product is instantly shared between the supply source and the supply destination.

According to a preferred embodiment of the present invention, an information sharing system for sharing information between a supply source of products and supply destinations of the products is provided. In the information sharing system, a database accumulating device accumulates portions of information about each product, the information being generated and inputted by the supply source and the supply destinations, respectively, in a database. An individual code identifying device identifies individual codes assigned to the supply source and the supply destinations when the database of the database accumulating device is accessed by the supply source and the supply destinations, respectively. An information linking device links distributed portions of information about the product, accumulated in the database of the database accumulating device, with each other, so that when a portion of the information about the product in the database is changed by the supply source or any of the supply destinations, the distributed portions of information on the product accumulated in the database are updated by the information linking device.

In the information sharing system, when a portion of the distributed information about the product, generated and inputted by the supply source and accumulated in the database of the database accumulating device, is changed by the supply source, a notice informing that the portion of the distributed information on the product in the database has been changed may be sent to each supply destination identified by the individual code identifying device. Likewise, when portions of the distributed information about the product, generated and inputted by the supply destinations, respectively, and accumulated in the database of the database accumulating device, are changed by the supply destinations identified by the individual code identifying device, respectively, notices informing that the portions of the distributed information about the product in the database have been changed may be sent to the supply source, respectively.

In the information sharing system, master information for each product may include a product identification code assigned to the product, process identification codes assigned to respective processes for processing components units constituting the product, and specification information of each of the product and the component units, quality information and quantity information of each production lot of the product, specification change information of each specification information, and process change information and material change information of each process may be linked with the master information. Further, the quality information and the quantity information of each production lot of the product may be based on inspection data generated at an inspection process for the production lot at the supply source or at any of the supply destinations identified by the individual code identifying device. Furthermore, the quality information and the quantity information of each production lot of the product may be linked with order information of each supply destination identified by the individual code identifying device.

In the information sharing system, a portion of information on each product, generated and inputted by the supply source and the supply destinations, respectively, and accumulated in the database of the database accumulating device, may be designated to be kept confidential.

According to another preferred embodiment of the present invention, an information sharing system for sharing information between a supply source of products and supply destinations of the products includes a database accumulating device configured to accumulate pieces of information on each product, that are generated and inputted by the supply source and the supply destinations, respectively, and that are not peculiar to respective supply destinations, in a database, and a client-peculiar database accumulating device configured to accumulate pieces of information on each product, that are generated and inputted by the supply source and the supply destinations, respectively, and that are peculiar to respective supply destinations, in client-peculiar databases. In this information sharing system, an individual code identifying device is configured to identify individual codes assigned to the supply source and the supply destinations, respectively, when the database of the database accumulating device and the client-peculiar databases of the client-peculiar database accumulating device are accessed by the supply source and the supply destinations, respectively. An information linking device is configured to link the pieces of information on the product accumulated in the database of the database accumulating device and the pieces of information on the product accumulated in the client-peculiar databases of the client-peculiar database accumulating device, with each other, respectively, so that when a part of the pieces of information on the product in the database of the database accumulating device or a part of the pieces of information on the product in the client-peculiar databases of the client-peculiar database accumulating device is changed by the supply source or any of the supply destinations, the pieces of information on the product accumulated in the database of the database accumulating device and the pieces of information on the product accumulated in the client-peculiar databases of the client-peculiar database accumulating device are updated, respectively, by the information linking device.

In the information sharing system immediately above, when a part of the pieces of information on the product, generated and inputted by the supply source and accumulated in the database of the database accumulating device, or a part of the pieces of information on the product, generated and inputted by the supply source and accumulated in the client-peculiar databases of the client-peculiar database accumulating device, is changed by the supply source, a notice informing that the part of the pieces of information on the product in the database of the database accumulating device or the part of the pieces of information on the product in the client-peculiar databases of the client peculiar-database accumulating device has been changed may be sent to each supply destination identified by the individual code identifying device, and when parts of the pieces of information on the product, generated and inputted by the supply destinations, respectively, and accumulated in the databases of the database accumulating device, or parts of the pieces of information on the product, generated and inputted by the supply destinations, respectively, and accumulated in the client-peculiar databases of the client-peculiar database accumulating device, are changed by the supply destinations identified by the individual code identifying device, respectively, notices informing that the parts of the pieces of information on the product in the database of the database accumulating device or the parts of the pieces of information on the product in the client-peculiar databases of the client peculiar-database accumulating device have been changed may be sent to the supply source, respectively.

In the information sharing system, master information for each product may include a product identification code assigned to the product, process identification codes assigned to respective processes for processing components units constituting the product, and specification information of each of the product and the component units, and quality information and quantity information of each production lot of the product, specification change information of each specification information, and process change information and material change information of each process may be linked with the master information. Further, the quality information and the quantity information of each production lot of the product may be based on inspection data generated at an inspection process for the production lot at the supply source or at any of the supply destinations identified by the individual code identifying device. Furthermore, the quality information and the quantity information of each production lot of the product may be linked with order information of each supply destination identified by the individual code identifying device.

In the information sharing system, a part or the whole part of the pieces of information on each product accumulated in the database of the data accumulating device and a part or the whole part of the pieces of information on each product accumulated in the client-peculiar databases of the client-peculiar database accumulating device can be designated not to be disclosed, respectively.

According to still another preferred embodiment of the present invention, an information sharing method of sharing information between a supply source of products and supply destinations of the products is provided. The method includes the steps of: accumulating pieces of information on each product, generated and inputted by the supply source and the supply destinations, respectively, in a database; identifying individual codes assigned to the supply source and the supply destinations, respectively, when the database is accessed by the supply source and the supply destinations, respectively; and linking the pieces of information on the product, accumulated in the database in the database accumulating step, with each other, so that when a part of the pieces of information on the product in the database is changed by the supply source or any of the supply destinations, the pieces of information on the product in the database are updated.

In the information sharing method, when a part of the pieces of information on the product, generated and inputted by the supply source and accumulated in the database in the database accumulating step, is changed by the supply source, a notice informing that the part of the pieces of information on the product in the database has been changed may be sent to each supply destination identified in the individual code identifying step, and when parts of the pieces of information on the product, generated and inputted by the supply destinations, respectively, and accumulated in the database in the database accumulating step, are changed by the supply destinations identified in the individual code identifying step, respectively, notices informing that the parts of the pieces of the information on the product in the database have been changed may be sent to the supply source, respectively.

In the information sharing method, master information for each product may include a product identification code assigned to the product, process identification codes assigned to respective processes for processing components units constituting the product, and specification information of each of the product and the component units, and quality information and quantity information of each production lot of the product, specification change information of each specification information, and process change information and material change information of each process may be linked with the master information. Further, the quality information and the quantity information of each production lot of the product may be based on inspection data generated at an inspection process for the production lot at the supply source or at any of the supply destinations identified in the individual code identifying step. Furthermore, the quality information and the quantity information of each production lot of the product may be linked with order information of each supply destination identified in the individual code identifying step.

In the information sharing method, a part or the whole part of the pieces of information on each product, generated and inputted by the supply source and the supply destinations, respectively, and accumulated in the database in the database accumulating step, can be designated not to be disclosed.

According to another preferred embodiment of the present invention, an information sharing method of sharing information between a supply source of products and supply destinations of the products includes the steps of: accumulating pieces of information on each product, that are generated and inputted by the supply source and the supply destinations, respectively, and that are not peculiar to respective supply destinations, in a database; accumulating pieces of information on each product, that are generated and inputted by the supply source and the supply destinations, respectively, and that are peculiar to respective supply destinations, in client-peculiar databases; identifying individual codes assigned to the supply source and the supply destinations, respectively, when the database and the client-peculiar databases are accessed by the supply source and the supply destinations, respectively; and linking the pieces of information on the product accumulated in the database in the database accumulating step and the pieces of information on the product accumulated in the client-peculiar databases in the client-peculiar database accumulating step, with each other, respectively, so that when a part of the pieces of information on the product in the database or a part of the pieces of information on the product in the client-peculiar databases is changed by the supply source or any of the supply destinations, the pieces of information on the product in the database and the pieces of information on the product in the client-peculiar databases are updated, respectively.

In the information sharing method, when a part of the pieces of information on the product, generated and inputted by the supply source and accumulated in the database in the database accumulating step, or a part of the pieces of information on the product, generated and inputted by the supply source and accumulated in the client-peculiar databases in the client-peculiar database accumulating step, is changed by the supply source, a notice informing that the part of the pieces of information on the product in the database or the part of the pieces of information on the product in the client-peculiar databases has been changed may be sent to each supply destination identified in the individual code identifying step, and when parts of the pieces of information on the product, generated and inputted by the supply destinations, respectively, and accumulated in the database in the database accumulating step, or parts of the pieces information on the product, generated and inputted by the supply destinations, respectively, and accumulated in the client-peculiar databases in the client-peculiar database accumulating step, are changed by the supply destinations identified in the individual code identifying step, respectively, notices informing that the parts of the pieces of the information on the product in the database or the parts of the pieces of information on the product in the client-peculiar databases have been changed may be sent to the supply source, respectively.

In the information sharing method, master information for each product may include a product identification code assigned to the product, process identification codes assigned to respective processes for processing components units constituting the product, and specification information of each of the product and the component units, and quality information and quantity information of each production lot of the product, specification change information of each specification information, and process change information and material change information of each process may be linked with the master information. Further, the quality information and the quantity information of each production lot of the product may be based on inspection data generated at an inspection process for the production lot at the supply source or at any of the supply destinations identified in the individual code identifying step. Furthermore, the quality information and the quantity information of each production lot of the product are linked with order information of each supply destination identified in the individual code identifying step.

In the information sharing method, a part or the whole part of the pieces of information on each product accumulated in the database in the data accumulating step and a part or the whole part of the pieces of information on each product accumulated in the client-peculiar databases in the client-peculiar database accumulating step can be designated not to be disclosed, respectively.

According to still another preferred embodiment of the present invention, a computer program product directly loadable into an internal memory of a computer, including computer program instructions which when executed by the computer causes an information sharing system to perform an information sharing operation of sharing information of products between a supply source of the products and supply destinations of the products, is provided. The information sharing operation includes the steps of: accumulating pieces of information on each product, generated and inputted by the supply source and the supply destinations, respectively, in a database; identifying individual codes assigned to the supply source and the supply destinations, respectively, when the database is accessed by the supply source and the supply destinations, respectively; and linking the pieces of information on the product, generated and inputted by the supply source and the supply destinations, respectively, and accumulated in the database in the database accumulating step, with each other, so that when a part of the pieces of information on the product in the database is changed by the supply source or any of the supply destinations, the pieces of information on the product in the database are updated.

In the computer program product, when a part of the pieces of information on the product, generated and inputted by the supply source and accumulated in the database in the database accumulating step, is changed by the supply source, a notice informing that the part of the pieces of information on the product in the database has been changed may be sent to each supply destination identified in the individual code identifying step, and when parts of the pieces of information on the product, generated and inputted by the supply destinations, respectively, and accumulated in the database in the database accumulating step, are changed by the supply destinations identified in the individual code identifying step, respectively, notices informing that the parts of the pieces of the information on the product in the database have been changed may be sent to the supply source, respectively.

In the computer program product, master information for each product includes a product identification code assigned to the product, process identification codes assigned to respective processes for processing components units constituting the product, and specification information for each of the product and the component units, and quality information and quantity information of each production lot of the product, specification change information of each specification information, and process change information and material change information of each process may be linked with the master information. Further, the quality information and the quantity information of each production lot of the product may be based on inspection data generated at an inspection process for the production lot at the supply source or at any of the supply destinations identified in the individual code identifying step. Furthermore, the quality information and the quantity information of each production lot of the product are linked with order information of each supply destination identified in the individual code identifying step.

In the computer program product, a part or the whole part of the pieces of information on each product, generated and inputted by the supply source and the supply destinations, respectively, and accumulated in the database in the database accumulating step, can be designated not to be disclosed.

### BRIEF DESCRIPTION OF THE DRAWINGS

A more complete appreciation of the present invention and many of the attendant advantages thereof will be readily obtained as the same becomes better understood by reference to the following detailed description when considered in conjunction with accompanying drawings, wherein:

FIG. 1 is a schematic of an information sharing system according to an exemplary embodiment of the present invention;

FIG. 2 is a schematic for further explaining the information sharing system;

FIG. 3 is a schematic for explaining master information used in the exemplary embodiment of the information sharing system of FIG. 1;

FIG. 4 is a schematic for explaining how quality information and quantity information of a production lot of each component unit of a product are linked with the component unit in the information sharing system of FIG. 1;

FIG. 5 is a schematic for explaining how specification change information on each component unit of a product is linked with the component unit in the information sharing system of FIG. 1;

FIG. 6 is a schematic for explaining how process change information on each process is linked with the process in the information sharing system of FIG. 1; and

FIG. 7 is a schematic of an integrated database management device of the information sharing system of FIG. 1.

### DETAILED DESCRIPTION OF THE PREFERRED EMBODIMENTS

Referring now to the drawings, wherein like reference numerals designate identical or corresponding parts throughout the several views, preferred embodiments of the present invention are described.

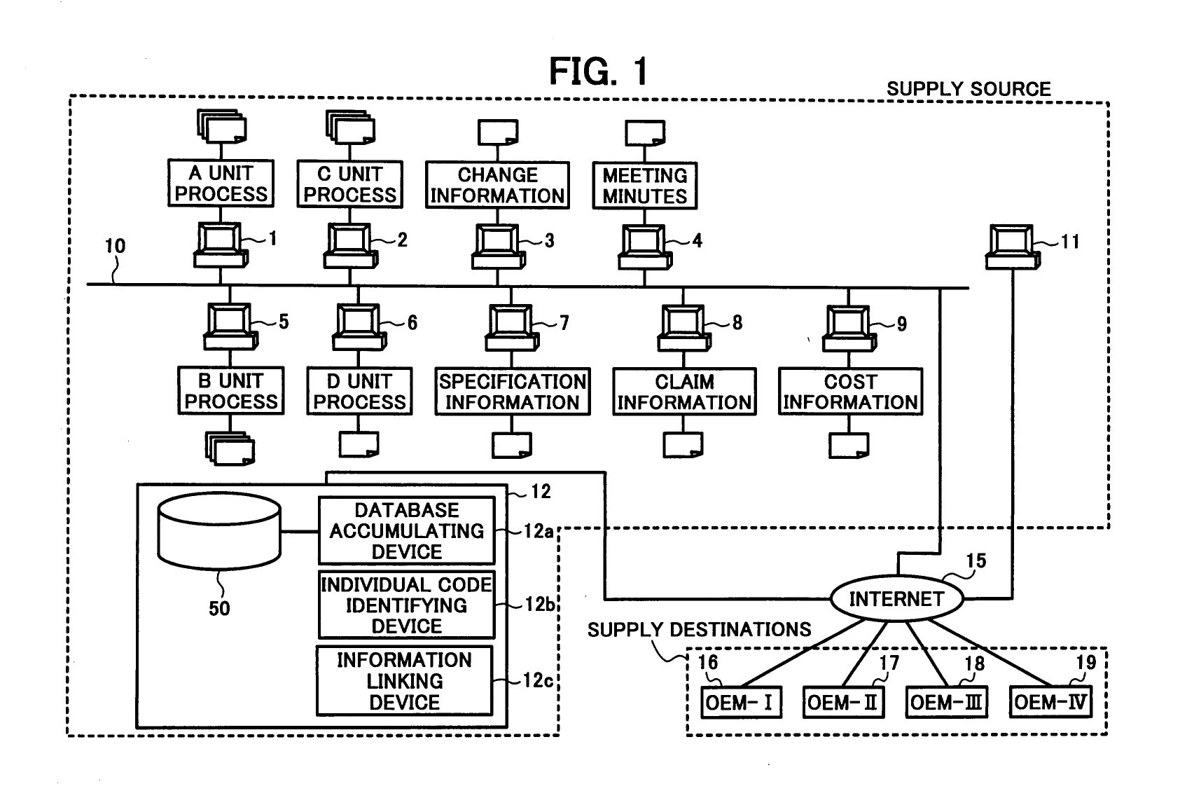

FIG. 1 is a schematic illustrating an exemplary configuration of an information sharing system for sharing information about a product between a supply source of the product and supply destinations of the product, according to an exemplary embodiment of the present invention. For example, the product in this embodiment is constituted of four component units, A, B, C and D, and the product is supplied to OEM clients I, II, III, and IV, as the supply destinations. The information sharing system includes an A unit process terminal 1, a B unit process terminal 5, a C unit process terminal 2, and a D unit process unit terminal 6, used in respective production processes for the product for inputting quality information of the A, B, C, and D component units, respectively. The information sharing system further includes a change information terminal 3 for inputting change information, a meeting minutes terminal 4 for inputting, for example, minutes of meetings between the supply source and the supply destinations, a specification information terminal 7 for inputting information of a change when a specification change occurs. The information sharing system further includes a claim information terminal 8 for inputting claim information, a cost information terminal 9 for inputting cost information of the product, a data reference terminal 11 for referring data at the supply destinations, an integrated database management device 12 for storing information about the product, a network 10, for example, a LAN, for connecting the above-described terminals 1-9 with each other, and a network, such as, for example, Internet 15, connected with external servers.

The information sharing system further includes an OEM-I terminal 16, an OEM-II terminal 17, an OEM-III terminal 18, and an OEM-IV terminal 19, provided at respective OEM clients as the supply destinations and connected with Internet 15 to access the integrated database management device 12. The A unit process terminal 1, the B unit process terminal 5, the C unit process terminal 2, the D unit process unit terminal 6, the change information terminal 3, the meeting minutes terminal 4, the specification information terminal 7, the claim information terminal 8, the cost information terminal 9, the data reference terminal 11, and the integrated database management device 12 are provided at the supply source. It will be appreciated that the integrated database management device 12 may be provided outside of the supply source, for example, as an outside third party facility. Furthermore, in this configuration, the integrated database management device 12 shown to be connected with the network 10 via the Internet 15 may be directly connected with the network 10. Each of the terminals 1-9 is shown to be directly connected with the network 10. However, terminals 1-9 may also be connected with the network 10 via the Internet 15.

The integrated database management device 12 includes a database accumulating device 12a to accumulate portions of information about each product in a database 50, an individual code identifying device 12b to identify individual codes of the supply source and the supply destinations, and an information linking device 12c to link with each other, as described in detail later in this specification, the portions of information about each product in the database 50.

In the above-described information system, at the supply source, information is inputted through respective terminals, such as the specification information terminal 7, etc, so that information is stored in the integrated database management device 12 to be accumulated by the database accumulating device 12a in the database 50. Each of the supply destinations accesses the integrated database management device 12 via their terminals provided at the supply destinations, such as the OEM-I terminal 16, etc., for inputting information into or referring to stored information in the database 50.

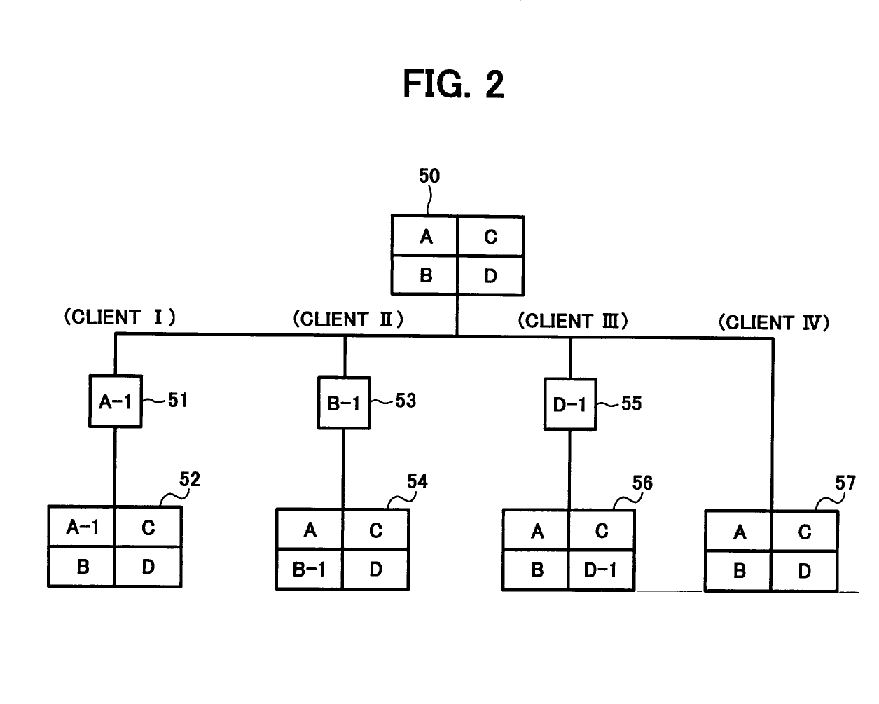

FIG. 2 is a schematic for further explaining the information sharing system shown in FIG. 1. The database 50 of the database accumulating device 12a in the integrated database management device 12 may, for example, include information of the four component units of the product, i.e., the A, B, C, and D units. The specification of a product is generally changed for each supply destination, i.e., each client. For example, a color of a cover, a logo mark, and an exterior design of the product may be changed for each client. Such changes are determined between the supply source and each client by consultation. In this embodiment, in the product for client I, the unit A is changed to a unit A-1, in the product for client II, the unit B is changed to a unit B-1, in the product for client III, the unit D is changed to a unit D-1, and in the product for client IV, no change is made. Thus, for the client I, the product database 50 is configured to be a product database 52 constituted of information of the A-1, B, C and D units, for the client II, the product database 50 is configured to be a product database 54 constituted of information of the A, B-1, C and D units, for the client III, the product database 50 is configured to be a product database 56 constituted of information of the A, B, C and D-1 units, and for the client IV, the product database 50 is configured to be a product database 57 constituted of information of the A, B, C and D units, respectively. Information regarding specific changes requested by the clients is inputted at the specification information terminal 7.

Each of the supply source and the supply destinations has an individual identification code, e.g., an ID code and a password, which is identified by the individual code identifying device 12b of the integrated database management device 12 when the database 50 of the integrated database management device 12 is accessed by the supply source or each supply destination. Thereby, only those supply destinations approved by the supply source can access the database 50 of the integrated database management device 12.

Portions of information about each product, stored, for example, in a distributed manner, in the database 50 of the integrated database management device 12 are linked with each other in a reliable manner by the information linking device 12c of the integrated database management device 12, so that, when a change is made to a portion of the information about the product stored in the database 50, all other portions of information stored in the database 50, and relating to the changed portion, are changed. At the same time, a notice of the change is also provided to the supply source or the supply destinations. For example, when quality information of a product is changed by the supply source, a notice of such change is sent in real-time to the supply destinations identified by respective individual identification codes, so that the supply destinations can confirm the change by accessing the database 50 of the integrated database management device 12. Claim information and change in specification information about a product from each supply destination may be once sent to the supply source, so that each such information is examined at the supply source to be reflected in processing of the product. Thus, quick transmission and sharing of information between the supply source and the supply destinations are reliably performed.

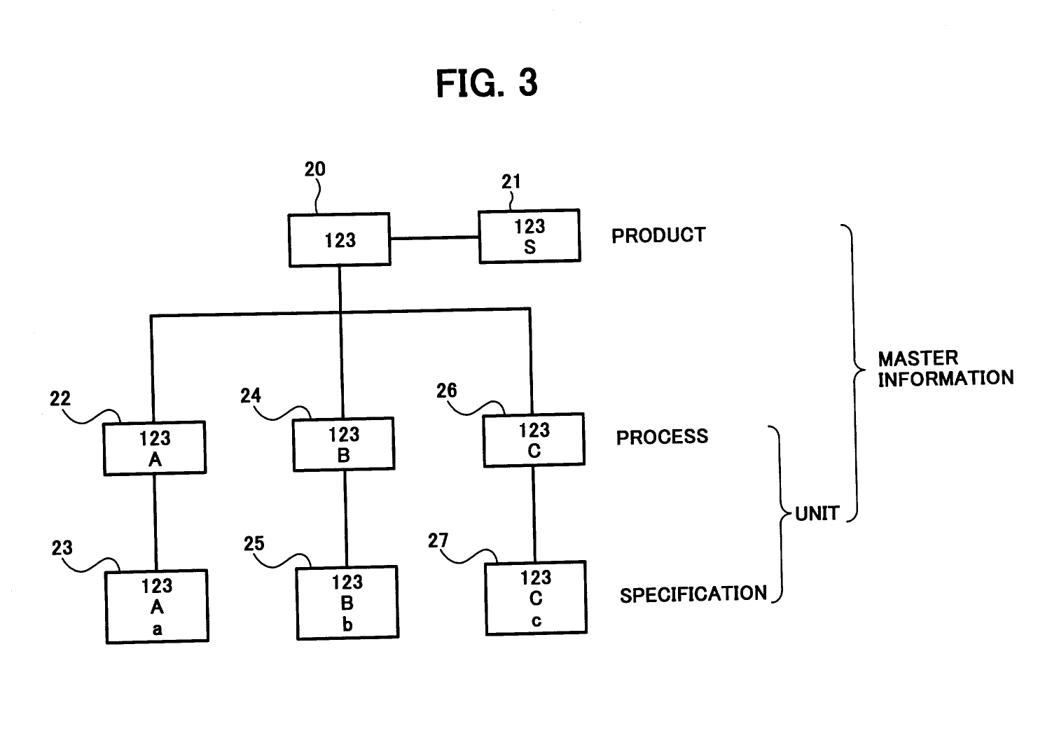

FIG. 3 is a schematic for explaining master information used for each product in the information sharing system. For realizing timely provision of mutually related information generated at the supply source and the supply destinations to each other, and retrieval of past information as well, as illustrated in FIG. 3, the master information for each product includes a product identification code 20 assigned to the product, a process identification code-A 22 assigned to a process for the unit A, a process identification code-B 24 assigned to a process for the unit B, and a process identification code-C 26 assigned to a process for the unit C. The master information further includes a specification information S 21 representing a specification of a product, a unit specification information “a” 23 representing a specification of the unit A, a unit specification information “b” 25 representing a specification of the unit B, and a unit specification information “c” 27 representing specification of the unit C. The component unit D is omitted in this example.

Further referring to the exemplary schematic of FIG. 3, suppose that a code of 123 is assigned to the product identification code 20, and a code of 123*S is assigned to the specification information S 21. Then, in order to link the process identification code-A 22 of the unit A, the process identification code-B 24 of the unit B, and the process identification code-C 26 of the unit C with the product identification code 20 having the code of 123, respectively, a code of 123*A is assigned to the process identification code-A 22, a code of 123*B is assigned to the process identification code-B 24, and a code of 123*C is assigned to the process identification code-C 26. Furthermore, in order to link the unit specification information “a” 23 of the unit A, the unit specification information “b” 25 of the unit B, and the unit specification information “c” 27 of the unit C with the product identification code 20, a code of 123*A*a is assigned to the unit specification information “a” 23, a code of 123*B*b is assigned to the unit specification information “b” 25, and a code of 123*C*c is assigned to the unit specification information “c” 27. Thus, the product identification code 20, the process identification code-A 22, and the unit specification code a 23 are respectively assigned with the codes having the code of 123 in common, i.e., 123, 123*A, and 123*A*a. Thus, the present invention ensures that specification information of a product, each process information of the product, and specification information of each component unit of the product are always linked with the product.

The master information for each product may further include information relating to sale and production of the product, such as, for example, the followings:

i) client information including a client code, address, name of a person in-charge, e-mail address of the person in-charge, ID and a password, etc.,

ii) product information including a product code, product specification, etc.;

iii) inspection information including a product code, inspection items, an inspection standard, an inspection method, frequency of inspections, etc.;

iv) order information including a product code, a supply source, a supply destination, and a delivery place;

v) supply source information including a product code and a supply destination code;

vi) supply source product information including a product code, a supply source code, and a supply source product number;

vii) supply source product component information including a supply source product number and name, a component number and name, and an inspection type;

viii) other information including minutes of meetings, cost information, claim information, change information, etc.

Each of the above-described information may be designated to be disclosed or kept confidential.

The content of each master information may be subjected to change. For example, the specification of a product may change by a design change. If a change is made to specification information of a product for a client, and if the information regarding such change is not completely linked with the master information of the product, a difficulty arises because the change is not reflected on the product, and also at the same time it results in failure to communicate information about such change to the client.

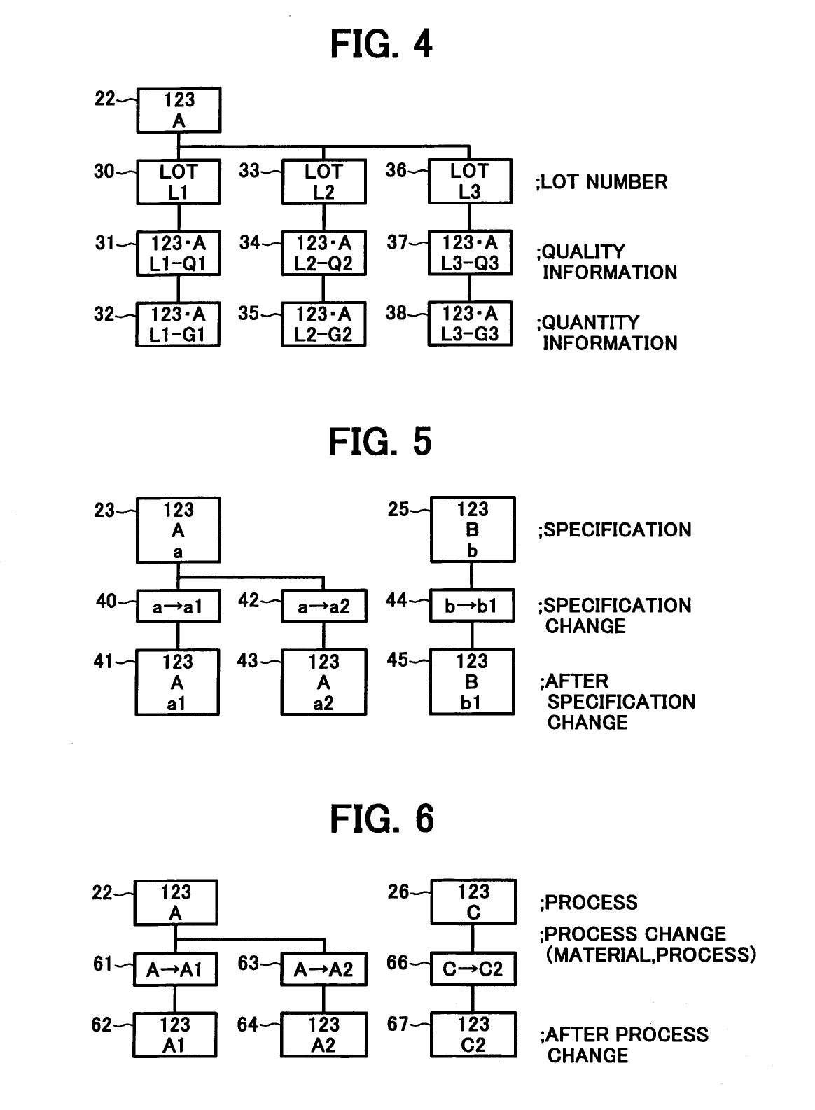

FIG. 4 is a schematic for explaining how quality information and quantity information of respective production lots of each component unit of a product are linked with the master information. Quality information of each component unit of a product changes for each production lot of the component unit, because workers and production conditions change for each production lot, thus changing the quality of processed component units for each production lot. Further, the number of satisfactory component units passing inspection also changes for each production lot. Therefore, it is important that quality information and quantity information of a product and component units of the product are managed for each production lot thereof.

In the exemplary embodiment shown in FIG. 4, considering the component unit A as an example, to which the code of 123*A is assigned as the process identification code-A 22, suppose that three lots of the unit A are produced, i.e., a lot L1 30, a lot L2 33, and a lot L3 36. Further, suppose that quality information Q1 31 representing quality of the lot L1, quality information Q2 34 representing quality of the lot L2, and quality information Q3 37 representing quality of the lot L3 are obtained from the three lots. Then, a code of 123*A L1-Q1 is assigned to the quality information Q1 31 of the lot L1, a code of 123*A L2-Q2 is assigned to the quality information Q2 34 of the lot L2, and a code of 123*A L3-Q3 is assigned to the quality information Q3 37 of the lot L3. Further, suppose that the quantities of satisfactory units passing inspection of the three lots are represented by quantity information G1 32, quantity information G2 35, and quantity information G3 38, respectively. Then, a code of 123*A L1-G1 is assigned to the quantity information G1 32 of the lot L1, a code of 123*A L2-G2 is assigned to the quantity information G2 35 of the lot L2, and a code of 123*A L3-G3 is assigned to the quantity information G3 38 of the lot L3. Thus, quality information and quantity information of respective production lots of each component unit of a product are linked with the component unit.

FIG. 5 is an exemplary schematic for explaining a case where specification information of a product is changed. A product specification may be changed based on a design change by the supply source or claim information from any of the supply destinations. The product specification may be changed a plurality of times in some cases.

In the information sharing system of this exemplary embodiment, when the specification of unit A represented by the specification information “a” 23, to which the code of 123*A*a is assigned, is changed to the specification represented by a specification information “a1” 41, a code of 123*A*a1 is assigned to the specification information “a1” 41. When the specification of unit A represented by the specification information “a” 23 is changed to the specification represented by a specification information “a2” 43, a code of 123*A*a2 is assigned to the specification information “a2” 43. Similarly, when the specification of unit B represented by the specification information “b” 25, to which the code of 123*B*b is assigned, is changed to the specification represented by a specification information “b1” 45, a code of 123*B*b1 is assigned to the specification information “b1” 45. Thus, specification change information on each component unit of a product is linked with the component unit.

FIG. 6 is an exemplary schematic for explaining a case where process information is changed. A production process of a product may be changed based on a change of a product part, a change in the product design, or a change of material used in manufacturing the product. Further, the process itself may be changed from a viewpoint of production efficiency.

In the information sharing system of this exemplary embodiment, if the process for the unit A represented by the process identification code-A 22, to which the code of 123*A is assigned, is changed to the process represented by a process identification code A1 62, a code of 123*A1 is assigned to the process identification code A1 62. Similarly, if the process for unit C represented by the process identification code-C 26, to which the code of 123*C is assigned, is changed to the process represented by a process identification code-C2 67, a code of 123*C2 is assigned to the process identification code-C2 67. Thus, process change information on each process is linked with the process.

Quality information and quantity information of each production lot of a product can be obtained in an inspection process for the production lot at the supply source or in inspection processes at the supply destinations. Actual data of an inspection result obtained in the inspection process for the production lot at the supply source, for example, can be used for the quality information of the production lot of the product. The data obtained by an inspection apparatus used in the inspection process can be used, directly or after batch processing thereof, for the quality information of the production lot. Further, the actual number of products passing inspection of the inspection process for the production lot can be used for the quantity information of the production lot of the product. Thus, in the information sharing system of this embodiment, quality information and quantity information of each production lot of a product may be based on inspection data obtained in an inspection process at the supply source or inspection processes at the supply destinations. Thereby, quick provision of accurate data of the product to both the supply and destination sides is realized.

When each of the supply destinations places an order of a product from the supply source, one should be able to understand a production status of the product at the supply source, because, for example, when short supply of a product part, or failure in the production facility occurs at the supply source, thereby causing a reduction in the production quantity, orders received and sales plan of the product must be adjusted accordingly. In the information sharing system of this exemplary embodiment, as described above, quantity information of the product can be understood in advance by accessing the database 50 of the integrated database management device 12, thereby the supply destinations can adjust their order and sales plans for the product in a timely manner.

Some data or information of the supply source may be undesirable to be disclosed to the supply destinations. For example, cost information may be desired to be kept confidential. Accordingly, the information sharing system of the present invention is configured such that each of the supply source and supply destinations can designate a portion of information or the entire information about each product to be kept confidential and therefore not to be disclosed. Thus, proprietary information can be prevented from being leaked.

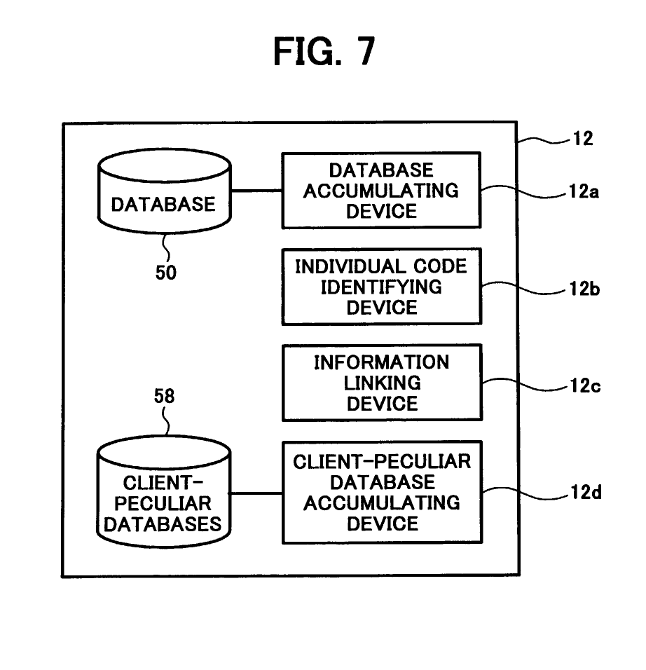

Further, it is preferable that the capacity of the database 50 of the database accumulating device 12a in the integrated database management device 12 be selected in order to perform database management with ease. From this point of view, as illustrated in FIG. 7, the integrated database management device 12 may be configured to include a client-peculiar database accumulating device 12d for accumulating information peculiar/specific to respective supply destinations in client-peculiar databases 58, separately from the database accumulating device 12a. In this case, information about each product, which is not peculiar or specific to respective supply destinations, is accumulated by the database accumulating device 12a in the database 50, and information about each product, which is peculiar or specific to respective supply destinations, is accumulated by the client-peculiar database accumulating device 12d in the client-peculiar databases 58. For example, the specifications of unit A-1 for the client I, unit B-1 for the client II, and unit D-1 for the client III can be accumulated by the client-peculiar database accumulating device 12d in respective areas of the client-peculiar databases 58 for the client I, the client II, and the client II in the integrated database management device 12. Thereby, the capacity of the database 50 of the database accumulating device 12a in the integrated database management device 12 is minimized and the management thereof is facilitated. When transmitting information about each product to any of the supply destinations, portions of information that are peculiar or specific to respective supply destinations are transmitted from the client-peculiar databases 58 of the client-peculiar database accumulating device 12d, respectively. Also, portions of information about each product and not peculiar or specific to the respective supply destinations, i.e., portions of information about each product common to all supply destinations, are transmitted from the database 50 of the database accumulating device 12a in the integrated database management device 12.

The mechanism and processes set forth in the present description may be implemented using a conventional general purpose microprocessor programmed according to the teachings in the present specification, as will be appreciated to those skilled in the relevant arts. In particular, the mechanism and processes may be implemented by each of the terminals 1-9, 11, 16-19, and the integrated database management device 12. Each of the terminals 1-9, 11, 16-19, and the integrated database management device 12 can be a conventional general purpose microprocessor or a computer programmed according the teachings in the present specification. Appropriate software coding can be readily prepared by skilled programmers based on the teachings of the present disclosure, as will also be apparent to those skilled in the relevant arts.

The present invention thus includes a computer program product which may be hosted on a storage medium and include instructions which can be used to program a microprocessor to perform a process in accordance with the present invention. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Numerous additional modifications and variations of the present invention are possible in light of the above teachings. It is therefore to be understood that within the scope of the appended claims, the present invention may be practiced otherwise than as specifically described herein.

The present application claims priority and contains subject matter of Japanese Patent Application No. 2001-315296 filed in the Japanese Patent Office on Oct. 12, 2001, and the entire contents of which are hereby incorporated herein by reference.

What is claimed is:

1. An information sharing system for sharing information between a supply source of products and supply destinations of the products, comprising:
a database accumulating device configured to accumulate various portions of information about each product, generated and inputted by the supply source and the supply destinations, respectively, in a database;
an individual code identifying device configured to identify individual codes assigned to the supply source and the supply destinations when said database is accessed by the supply source and the supply destinations, respectively; and
an information linking device configured to link the various portions of information about the product, accumulated in said database, so that when a portion of information about the product in the database is changed by the supply source or any of the supply destinations, various other portions of information about the product accumulated in the database are updated by the information linking device.

2. The information sharing system according to claim 1,
wherein when a portion of information about the product, generated and inputted by the supply source and accumulated in the database of the database accumulating device, is changed by the supply source, a notice informing the change is sent to each supply destination identified by the individual code identifying device, and when portions of information about the product, generated and inputted by the supply destinations, respectively, and accumulated in the database of the database accumulating device, are changed by the supply destinations identified by the individual code identifying device, respectively, notices informing the change are sent to the supply source, respectively.

3. The information sharing system according to claim 1,
wherein master information for each product includes a product identification code assigned to the product, process identification codes assigned to respective processes for processing components units constituting the product, and specification information of each of the product and the component units, and
wherein quality information and quantity information of each production lot of the product, specification change information of each specification information, and process change information and material change information of each process are linked with the master information.

4. The information sharing system according to claim 3,
wherein the quality information and the quantity information of each production lot of the product are based on inspection data generated at an inspection process for the production lot at the supply source or at any of the supply destinations identified by the individual code identifying device.

5. The information sharing system according to claim 3,
wherein the quality information and the quantity information of each production lot of the product are linked with order information of each supply destination identified by the individual code identifying device.

6. The information sharing system according to claim 1,
wherein select portions of information about each product, generated and inputted by the supply source and the supply destinations, respectively, and accumulated in the database of the database accumulating device, can be designated not to be disclosed.

7. An information sharing system for sharing information between a supply source of products and supply destinations of the products, comprising:
a database accumulating device configured to accumulate portions of information about each product in a database, said information being generated and inputted by the supply source and the supply destinations, respectively, and said information not being peculiar to respective supply destinations;
a client-peculiar database accumulating device configured to accumulate portions of information about each product in client-peculiar databases, said information being generated and inputted by the supply source and the supply destinations, respectively, and said portions of information being peculiar to respective supply destinations;
an individual code identifying device configured to identify individual codes assigned to the supply source and the supply destinations, respectively, when the database of the database accumulating device and the client-peculiar databases are accessed by the supply source and the supply destinations, respectively; and
an information linking device configured to link the portions of information about the product accumulated in the database of the database accumulating device and the portions of information about the product accumulated in the client-peculiar databases of the client-peculiar database accumulating device, with each other, respectively, so that when a portion of information about the product in the database of the database accumulating device or a portion of information about the product in the client-peculiar databases of the client-peculiar database accumulating device is changed by the supply source or any of the supply destinations, the portions of information about the product accumulated in the database of the database accumulating device and the portions of information about the product accumulated in the client-peculiar databases of the client-peculiar database accumulating device are updated, respectively, by the information linking device.

8. The information sharing system according to claim 7,
wherein when a portion of information about the product, generated and inputted by the supply source and accumulated in the database of the database accumulating device, or a portion of information about the product, generated and inputted by the supply source and accumulated in the client-peculiar databases of the client-peculiar database accumulating device, is changed by the supply source, a notice informing of the change is sent to each supply destination identified by the individual code identifying device, and when portions of information about the product, generated and inputted by the supply destinations, respectively, and accumulated in the databases of the database accumulating device, or portions of information about the product, generated and inputted by the supply destinations, respectively, and accumulated in the client-peculiar databases of the client-peculiar database accumulating device, are changed by the supply destinations identified by the individual code identifying device, respectively, notices informing of the change are sent to the supply source, respectively.

9. The information sharing system according to claim 7,
wherein master information for each product includes a product identification code assigned to the product, process identification codes assigned to respective processes for processing components units constituting the product, and specification information of each of the product and the component units, and
wherein quality information and quantity information of each production lot of the product, specification change information of each specification information, and process change information and material change information of each process are linked with the master information.

10. The information sharing system according to claim 9,
wherein the quality information and the quantity information of each production lot of the product are based on inspection data generated at an inspection process for the production lot at the supply source or at any of the supply destinations identified by the individual code identifying device.

11. The information sharing system according to claim 9,
wherein the quality information and the quantity information of each production lot of the product are linked with order information of each supply destination identified by the individual code identifying device.

12. The information sharing system according to claim 7,
wherein select portions of information about each product accumulated in the database of the data accumulating device and select portions of information about each product accumulated in the client-peculiar databases of the client-peculiar database accumulating device can be designated not to be disclosed, respectively.

13. An information sharing system for sharing information between a supply source of products and supply destinations of the products, comprising:
database accumulating means for accumulating various portions of information about each product, generated and inputted by the supply source and the supply destinations, respectively, in a database;
individual code identifying means for identifying individual codes assigned to the supply source and the supply destinations, respectively, when said database is accessed by the supply source and the supply destinations, respectively; and
information linking means for linking the various portions of information about the product, accumulated in said database, so that when a portion of information about the product in the database is changed by the supply source or any of the supply destinations, various other portions of information about the product accumulated in the database of the database accumulating means are updated by the information linking means.

14. An information sharing system for sharing information between a supply source of products and supply destinations of the products, comprising:
database accumulating means for accumulating portions of information about each product in a database, said information being generated and inputted by the supply source and the supply destinations, respectively, and said information being not peculiar to respective supply destinations;
client-peculiar database accumulating means for accumulating information about each product in client-peculiar databases, the information in the client-peculiar databases being generated and inputted by the supply source and the supply destinations, respectively, and peculiar to respective supply destinations;
individual code identifying means for identifying individual codes assigned to the supply source and the supply destinations, respectively, when the database of the database accumulating means and the client-peculiar databases of the client-peculiar database accumulating means are accessed by the supply source and the supply destinations, respectively; and
information linking means for linking the portions of information about the product accumulated in the database of the database accumulating means and the portions of information about the product accumulated in the client-peculiar databases, with each other, respectively, so that when a portion of information about the product in the database of the database accumulating means or a portion of information about the product in the client-peculiar databases of the client-peculiar database accumulating means is changed by the supply source or any of the supply destinations, the portions of information about the product accumulated in the database of the database accumulating means and the portions of information about the product in the client-peculiar databases are updated by the information linking means, respectively.

15. An information sharing method of sharing information between a supply source of products and supply destinations of the products, comprising the steps of:
accumulating information about each product in a database, the information being generated and inputted by the supply source and the supply destinations, respectively;
identifying individual codes assigned to the supply source and the supply destinations, respectively, when the database is accessed by the supply source and the supply destinations, respectively; and
linking portions of information about the product, accumulated in the database in the accumulating step, with each other, so that when a portion of information about the product in the database is changed by the supply source or any of the supply destinations, the portions of information on the product in the database are updated.

16. An information sharing method of sharing information between a supply source of products and supply destinations of the products, comprising the steps of:
accumulating portions of information about each product in a database, said information generated and inputted by the supply source and the supply destinations, respectively, and that are not peculiar to respective supply destinations;
accumulating portions of information about each product in client-peculiar databases, the information being generated and inputted by the supply source and the supply destinations, respectively, and the information being peculiar to respective supply destinations,
identifying individual codes assigned to the supply source and the supply destinations, respectively, when the database and the client-peculiar databases are accessed by the supply source and the supply destinations, respectively; and
linking the portions of information about the product accumulated in the database in the database accumulating step and the portions of information about the product accumulated in the client-peculiar databases in the client-peculiar database accumulating step, with each other, respectively, so that when a portion of information about the product in the database or a part of the pieces of information on the product in the client-peculiar databases is changed by the supply source or any of the supply destinations, the portions of information about the product in the database and the portions of information about the product in the client-peculiar databases are respectively updated.

17. A computer program product, comprising:
a computer storage medium and a computer program code mechanism embedded in the computer storage medium for causing a computer to control an information sharing system for sharing information between a supply source of products and supply destinations of the products, the computer program code mechanism including;
a first computer code mechanism configured to accumulate portions of information about each product in a database, the information being generated and inputted by the supply source and the supply destinations, respectively;
a second computer code mechanism configured to identify individual codes assigned to the supply source and the supply destinations, respectively, when the database of the first computer code mechanism is accessed by the supply source and the supply destinations, respectively; and
a third computer code mechanism configured to link the portions of information about the product, said information being accumulated in the database of the first computer code mechanism, the information being generated and inputted by the supply source and the supply destinations, respectively, so that when a portion of information about the product in the database is changed by the supply source or any of the supply destinations, other portions of information about the product in the database are updated by the third computer code mechanism.

18. A computer program product, comprising:
a computer storage medium and a computer program code mechanism embedded in the computer storage medium for causing a computer to control an information sharing system for sharing information between a supply source of products and supply destinations of the products, the computer program code mechanism including;
a first computer code mechanism configured to accumulate portions of information about each product and portions of information not peculiar to respective supply destinations in a database, the information being generated and inputted by the supply source and the supply destinations, respectively;
a second computer code mechanism configured to accumulate portions of information about each product and portions of information peculiar to respective supply destinations in client-peculiar databases, the information being generated and inputted by the supply source and the supply destinations, respectively;
a third computer code mechanism configured to identify individual codes assigned to the supply source and the supply destinations, respectively, when the database of the first computer code mechanism and the client-peculiar databases of the second computer code mechanism are accessed by the supply source and the supply destinations, respectively; and
a fourth computer code mechanism configured to link the portions of information about the product accumulated in the database of the first computer code mechanism and the portions of information about the product accumulated in the client-peculiar databases of the second computer code mechanism, with each other, respectively, so that when a portion of information about the product accumulated in the database of the first computer code mechanism or a portion of information about the product accumulated in the client-peculiar databases of the second computer code mechanism is changed by the supply source or any of the supply destinations, the portions of information about the product accumulated in the database of the first computer code mechanism and the portions of information about the product accumulated in the client-peculiar databases of the second computer code mechanism are updated by the fourth computer code mechanism, respectively.

19. A computer program product directly loadable into an internal memory of a computer, comprising computer program instructions which when executed by the computer causes an information sharing system to perform an information sharing operation of sharing information of products between a supply source of the products and supply destinations of the products, the information sharing operation including the steps of:
accumulating portions of information about each product in a database, the information being generated and inputted by the supply source and the supply destinations, respectively;
identifying individual codes assigned to the supply source and the supply destinations, respectively, when the database is accessed by the supply source and the supply destinations, respectively; and
linking the portions of information about the product accumulated in the database in the database accumulating step, so that when a portion of information about the product in the database is changed by the supply source or any of the supply destinations, other portions of information about the product in the database are updated.

20. A computer program product directly loadable into an internal memory of a computer, comprising computer program instructions which when executed by the computer causes an information sharing system to perform an information sharing operation of sharing information of products between a supply source of the products and supply destinations of the products, the information sharing operation including the steps of:
accumulating portions of information about each product and said information being not peculiar to respective supply destinations in a database, the information being generated and inputted by the supply source and the supply destinations, respectively,
accumulating portions of information about each product and said information being peculiar to respective supply destinations, in client-peculiar databases, said information being generated and inputted by the supply source and the supply destinations, respectively,
identifying individual codes assigned to the supply source and the supply destinations, respectively, when the database and the client-peculiar databases are accessed by the supply source and the supply destinations, respectively; and
linking the portions of information about the product accumulated in the database in the database accumulating step and the portions of information about the product accumulated in the client-peculiar databases in the client-peculiar database accumulating step, with each other, respectively, so that when a portion of information about the product in the database or a portion of information about the product in the client-peculiar database accumulating step is changed by the supply source or any of the supply destinations, the portions of information about the product in the database and the portions of information about the product in the client-peculiar databases are updated, respectively.

21. A computer readable medium storing computer program instructions which when executed by a computer causes an information sharing system to perform an information sharing operation of sharing information of products between a supply source of the products and supply destinations of the products, the information sharing operation including the steps of:
accumulating portions of information about each product in a database, the information being generated and inputted by the supply source and the supply destinations, respectively;
identifying individual codes assigned to the supply source and the supply destinations, respectively, when the database is accessed by the supply source and the supply destinations, respectively; and
linking the portions of information about the product accumulated in the database in the database accumulating step, so that when a portion of information about the product in the database is changed by the supply source or any of the supply destinations, other portions of information about the product in the database are updated.

22. A computer readable medium storing computer program instructions which when executed by a computer causes an information sharing system to perform an information sharing operation of sharing information of products between a supply source of the products and supply destinations of the products, the information sharing operation including the steps of:
accumulating portions of information about each product, that are generated and inputted by the supply source and the supply destinations, respectively, and that are not peculiar to respective supply destinations, in a database;
accumulating portions of information about each product, that are generated and inputted by the supply source and the supply destinations, respectively, and that are peculiar to respective supply destinations, in client-peculiar databases,
identifying individual codes assigned to the supply source and the supply destinations, respectively, when the database and the client-peculiar databases are accessed by the supply source and the supply destinations, respectively; and
linking the portions of information about the product accumulated in the database in the database accumulating step and the portions of information about the product accumulated in the client-peculiar databases in the client-peculiar database accumulating step, with each other, respectively, so that when a portion of information about the product in the database or a portion of information about the product in the client-peculiar database accumulating step is changed by the supply source or any of the supply destinations, other portions of information about the product in the database and the portions of information about the product in the client-peculiar databases are updated, respectively.
